(19) United States
(12) Patent Application Publication
(10) Pub. No.: US 2010/0044343 A1
(43) Pub. Date: Feb. 25, 2010

(54) SUBSTRATE TREATMENT APPARATUS AND SUBSTRATE TREATMENT METHOD

(76) Inventors: Hiroshi Tomita, Yokohama-shi (JP); Linan Ji, Yokohama-Shi (JP); Hisashi Okuchi, Yokohama-Shi (JP); Tatsuhiko Koide, Yokohama-Shi (JP); Hiroyasu Iimori, Yokohama-Shi (JP); Hidekazu Hayashi, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/545,541

(22) Filed: Aug. 21, 2009

(30) Foreign Application Priority Data
Aug. 22, 2008 (JP) 2008-214583
Jun. 4, 2009 (JP) 2009-135093

(51) Int. Cl. C03C 15/00

(52) U.S. Cl. 216/83; 156/345.1; 156/345.37

(57) ABSTRACT

A substrate treatment apparatus for treating a substrate on which a plurality of patterns are formed adjacently, has a first chamber which has resistance to a chemical and cleans the substrate with the chemical; a second chamber which is disposed above or below the first chamber, has higher pressure resistance than the first chamber, and supercritically dries the substrate; and a gate unit which is provided between the first and second chambers and can be opened/closed.

### CROSS-REFERENCE TO RELATED APPLICATIONS

This application is based upon and claims the benefit of priority from the prior Japanese Patent Application No. 2008-214583, filed on Aug. 22, 2008, and No. 2009-135093, filed on Jun. 4, 2009, the entire contents of which are incorporated herein by reference.

### BACKGROUND OF THE INVENTION

1. Field of the Invention

The present invention relates to a substrate treatment apparatus and a substrate treatment method for treating a substrate such as a semiconductor substrate or a glass substrate with a chemical.

2. Background Art

In recent years, semiconductor devices are being miniaturized. For example, in a very fine structure having a line width of twenty-some nm or less, a problem is becoming apparent such that when a substrate is dried, patterns collapse due to surface tension of pure water, a chemical, or the like.

In a conventional art, for example, a state where the surface of a substrate is wet with pure water is changed to a state where the surface is wet with isopropyl alcohol (IPA) having surface tension lower than that of pure water and, after that, the substrate is dried. With the technique, collapse of patterns at a time of drying can be suppressed.

In the conventional art, however, when the aspect ratio of the pattern increases (for example, when the aspect ratio is 15 or higher), it is difficult to suppress collapse of the patterns.

In contrast, there is a method for cleaning a substrate with a supercritical fluid and drying it. In the method, for example, a high-pressure chamber mainly using a Stainless Used Steel (SUS) member is necessary. In a case of cleaning and drying a substrate in a single high-pressure chamber, only a weak acid or a weak alkali can be applied as the chemical.

There is a conventional substrate treatment apparatus which performs cleaning and drying in two different chambers (for example, refer to Japanese Patent Laid-Open No. 2004-128456). In the conventional substrate treatment apparatus, a wafer is carried in moisture vapor mist atmosphere between two chambers. In such a manner, when a wafer is carried between two chambers, the surface of the wafer is not dried.

In the substrate treatment apparatus, however, for example, in principle, a water-shedding wafer repels moisture also in the moisture vapor mist atmosphere, so that the surface-wet state cannot be maintained. Further, in a case of a water-shedding wafer, if the wafer is not carried, pure water can be put on the wafer even when the wafer is a hydrophobic wafer. However, if a wafer is carried, it is difficult to maintain a liquid which is put on the wafer. That is, when the wafer is carried, patterns formed on the wafer may collapse due to surface tension.

In another conventional substrate treatment apparatus, a wafer is carried in sealed gas atmosphere (for example, refer to Japanese Patent Laid-Open No. 2003-51474). By the technique, when a wafer is carried between two chambers, the surface of the wafer is not contaminated.

In the substrate treatment apparatus, however, for example, when a cleaned wafer is carried to another chamber, the surface of the wafer is dried, and patterns formed on the wafer may collapse due to surface tension.

### SUMMARY OF THE INVENTION

According to one aspect of the present invention, there is provided: a substrate treatment apparatus for treating a substrate on which a plurality of patterns are formed adjacently, comprising:

a first chamber which has resistance to a chemical and cleans the substrate with the chemical;

a second chamber which is disposed above or below the first chamber, has higher pressure resistance than the first chamber, and supercritically dries the substrate; and

a gate unit which is provided between the first and second chambers and can be opened/closed, wherein the substrate is cleaned with the chemical in the first chamber,

the gate unit is opened to make a first liquid flow between the first and second chambers and the substrate is moved in the first liquid in a manner such that a board surface of the substrate becomes parallel to a flowing direction of the first liquid, thereby carrying the substrate from the first chamber to the second chamber via the gate unit,

a supercritical fluid is supplied into the second chamber to replace the first liquid in the second chamber with the supercritical fluid, and

the substrate is subjected to supercritical drying in the second chamber.

According to another aspect of the present invention, there is provided: a substrate treatment method for treating a substrate on which a plurality of patterns are formed adjacently, comprising:

cleaning the substrate with a chemical in a first chamber having resistance to the chemical;

in a state where a first liquid flows between the first chamber and a second chamber disposed above or below the first chamber and having higher pressure resistance than the first chamber, moving the substrate in the first liquid in such a manner that a substrate face of the substrate is parallel to a flowing direction of the first liquid to thereby carry the substrate from the first chamber to the second chamber;

supplying a supercritical fluid into the second chamber to replace the first liquid in the second chamber with the supercritical fluid; and

performing supercritical drying on the substrate in the second chamber.

According to still another aspect of the present invention, there is provided: a substrate treatment apparatus for treating a substrate, comprising:

a chamber which supercritically dries the substrate; and

a pipe which is connected to the chamber and is supplies the supercritical fluid into the chamber,

wherein pure water is made flow in the pipe, and then a cleaning solution having vapor pressure higher than that of pure water is made flow in the pipe and discharged, thereby cleaning the inside of the pipe.

### BRIEF DESCRIPTION OF THE DRAWINGS

FIG. 1 is a state diagram showing the relations among pressure, temperature, and a phase state of a material;

FIG. 2 is a diagram showing an example of the configuration of a substrate treatment apparatus 100 in a first embodiment as an aspect of the present invention;

FIG. 3 is a diagram showing an example of operation of opening/closing a gate unit 3 in the substrate treatment apparatus 100 shown in FIG. 2;

FIG. 4 is a diagram showing an example of operation of opening/closing a gate unit 3 in the substrate treatment apparatus 100 shown in FIG. 2, and continuous from FIG. 3;

FIG. 5 is a diagram showing an example of operation of opening/closing a gate unit 3 in the substrate treatment apparatus 100 shown in FIG. 2, and continuous from FIG. 4;

FIG. 6 is a diagram showing a flow of processes of the substrate treatment method performed by the substrate treatment apparatus 100 of the first embodiment;

FIG. 7 is a diagram showing a process of the substrate treatment method performed by the substrate treatment apparatus 100 of the first embodiment;

FIG. 8 is a diagram showing a process of the substrate treatment method performed by the substrate treatment apparatus 100 of the first embodiment and continuous from FIG. 7;

FIG. 9 is a diagram showing a process of the substrate treatment method performed by the substrate treatment apparatus 100 of the first embodiment and continuous from FIG. 8;

FIG. 10 is a diagram showing a process of the substrate treatment method performed by the substrate treatment apparatus 100 of the first embodiment and continuous from FIG. 9;

FIG. 11 is a diagram showing a process of the substrate treatment method performed by the substrate treatment apparatus 100 of the first embodiment and continuous from FIG. 10;

FIG. 12 is a diagram showing a process of the substrate treatment method performed by the substrate treatment apparatus 100 of the first embodiment and continuous from FIG. 11; and

FIG. 13 is a diagram showing an example of the configuration of a substrate treatment apparatus 200 in a second embodiment as an aspect of the present invention.

### DETAILED DESCRIPTION

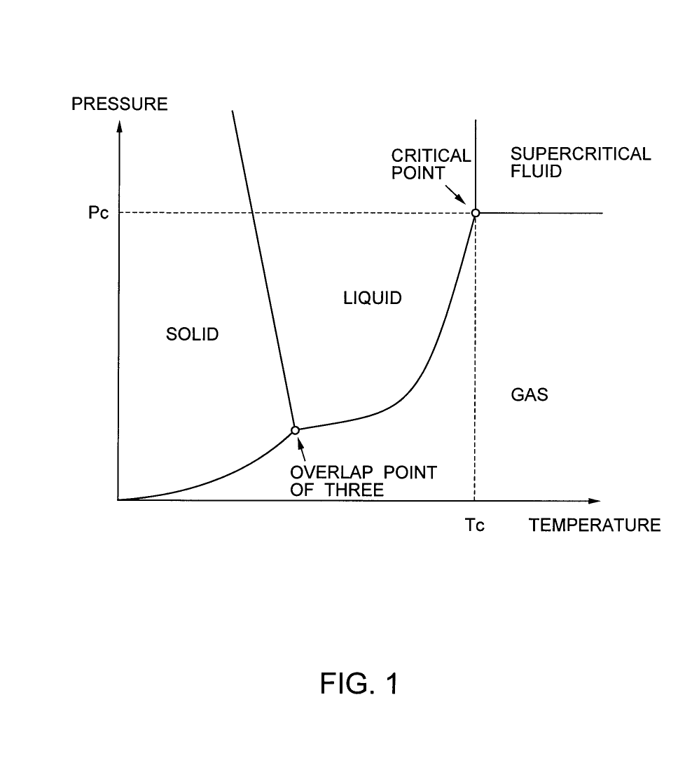

The above-described supercritical drying process will be described. FIG. 1 is a state diagram showing the relations among pressure, temperature, and a phase state of a material.

A function material of a supercritical fluid used for supercritical drying has three existence states of a gas phase (gas), a liquid phase (liquid), and a solid phase (solid) called three states.

As shown in FIG. 1, the three phases are defined by a vapor pressure curve (gas-liquid equilibrium line) showing the boundary between the gas phase and the liquid phase, a sublimation curve showing the boundary between the gas phase and the solid phase, and a fusion curve showing the boundary between the solid phase and the liquid phase. The point at which the three phases overlap is a triple point. The vapor pressure curve extends toward a high-temperature side from the triple point and reaches a critical point (Pc, Tc) as the limit where the gas phase and the liquid phase coexist. At the critical point, the density of the gas phase and that of the liquid phase are equal to each other, and the interface of the vapor-liquid coexistence state disappears.

At the critical point or higher, there is no distinction between the gas phase and the liquid phase, so that a material in this state is called a supercritical fluid. The supercritical fluid denotes a fluid compressed at high density at the critical temperature or higher. The supercritical fluid is similar to a gas with respect to a point that the spreading force of solvent molecules is dominant. On the other hand, the supercritical fluid is similar to a liquid with respect to a point that the influence of cohesion force of the molecules cannot be ignored. Thus, the supercritical fluid has a property of dissolving various materials.

Moreover, the density of the supercritical fluid can be continuously changed by temperature and pressure. Consequently, the density of the supercritical fluid can be arbitrarily adjusted from an ideal gas state to a density equal to a liquid. In particular, the density can be adjusted by a slight change in temperature and pressure around the critical point.

The supercritical fluid has wettability much higher than a liquid and has a characteristic that it easily penetrates even a fine structure.

The supercritical fluid can be dried without destroying a microstructure so as to directly shift from the supercritical state to a gas phase so that no interface between the gas and the liquid exists and capillary force (surface tension) does not work.

That is, the above-described supercritical drying denotes drying of a substrate by using the supercritical state of such a supercritical fluid.

As the supercritical fluid used for the supercritical drying, for example, carbon dioxide, ethanol, methanol, propanol, butanol, methane, ethane, propane, water, ammonium, ethylene, fluoromethane, or the like is selected.

The critical point of carbon dioxide is at temperature (Tc) of 31.1° C. and pressure (Pc) of 7.38 MPa which is relatively low temperature and low pressure, so that carbon dioxide is easily treated. Although the embodiment will be described using carbon dioxide, any of the above-described materials may be used as a supercritical fluid.

Embodiments of the present invention will be described below with reference to the drawings.

### First Embodiment

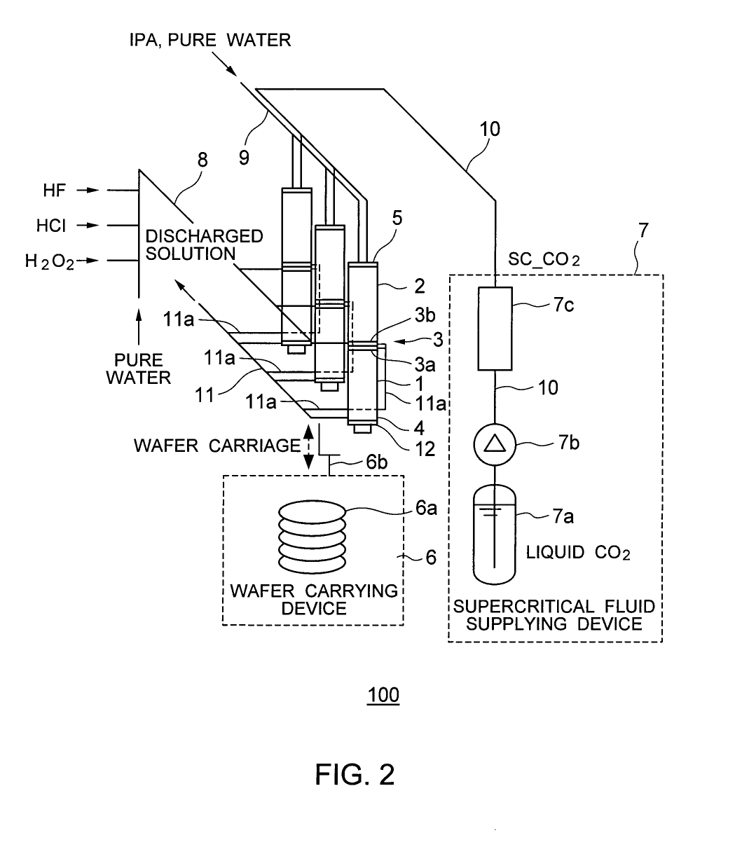

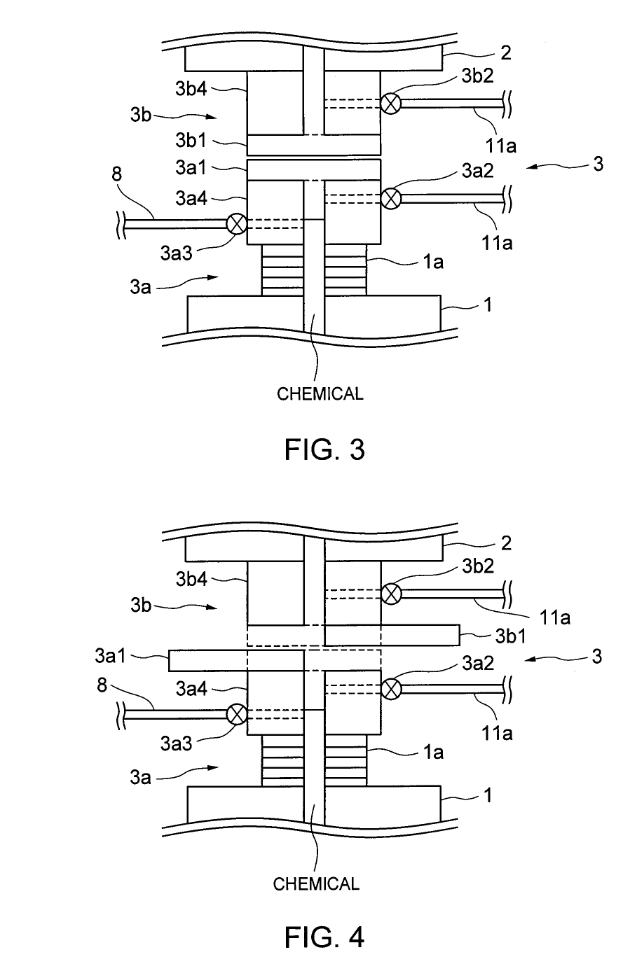

FIG. 2 is a diagram showing an example of the configuration of a substrate treatment apparatus 100 in a first embodiment as an aspect of the present invention. FIGS. 3 to 5 are diagrams showing an example of operation of opening/closing a gate unit 3 in the substrate treatment apparatus 100 shown in FIG. 2.

As shown in FIG. 2, the substrate treatment apparatus 100 has a first chamber 1, a second chamber 2, the gate unit 3, connection units 4 and 5, a wafer carrying device 6, a supercritical fluid supplying device 7, a cleaning-solution pipe 8, a replacement-solution pipe 9, a pipe 10, drainage pipes 11 and 11a, and an ultrasonic generator 12.

The substrate treatment apparatus 100 performs cleaning process, rinsing process, and drying process on a wafer 6a. On the wafer 6a (for example, a substrate such as a semiconductor substrate or a glass substrate), a plurality of patterns are formed adjacently.

The first chamber 1 has resistance to a chemical, in which a substrate is subjected to the cleaning process or rinsing process with the chemical. For example, the inner face of the first chamber 1 is coated with Teflon (registered trademark). The first chamber 1 is connected to the drainage pipe 11 via the connection unit 4 provided in the lower part.

The chemical contains, for example, strong acid such as H₂SO₄, HF, HCl, or H₂O₂ and strong alkali such as NH₄OH or choline. That is, to the first chamber 1, cleaning process using the strong acid and strong alkali can be applied. At a time of the cleaning process or rinsing process, the wafer 6a is fixed in the first chamber 1 so that its substrate surface is parallel to the perpendicular (vertical) direction.

The cleaning process includes a process of stripping a resist from the wafer 6a, a process of removing particles or metal impurities with alkali, acid, or the like, and a process of etching a film formed on the wafer 6a. The rinsing process is a process of rinsing the chemical used for the cleaning.

As shown in FIG. 2, the second chamber 2 is disposed above the first chamber 1. The second chamber 2 has pressure resistance higher than that of the first chamber 1 and performs supercritical drying on the wafer 6a. The second chamber 2 is made of, for example, SUS. The second chamber 2 is connected to the replacement-solution pipe 9 and the pipe 10 in the connection unit 5 provided above. The pipe 10 is connected to the second chamber 2 to supply the supercritical fluid to the second chamber 2.

The width in the second chamber 2 is set to, for example, about twice or three times as wide as the thickness of the wafer 6a. At a time of supercritical drying, the wafer 6a is fixed in the second chamber 2 so that its substrate face becomes parallel to the vertical (perpendicular) direction.

The gate unit 3 is provided between the first and second chambers 1 and 2. The gate unit 3 is configured with a first gate valve 3a provided in an upper part of the first chamber 1 and a second gate valve 3b provided in a lower part of the second chamber 2.

As shown in FIG. 3, the first gate valve 3a includes a first gate plate 3a1, a first valve 3a2, a second valve 3a3, and a first body 3a4.

The first body 3a4 is connected to the upper part of the first chamber 1 via an accordion Teflon pipe 1a. Between the first body 3a4 and the drainage pipe 11a, the first valve 3a2 is provided. Between the first body 3a4 and the chemical pipe 8, the second valve 3a3 is provided.

As shown in FIG. 3, the second gate valve 3b includes a second gate plate 3b1, a third valve 3b2, and a second body 3b4.

The second body 3b4 is connected to the bottom of the second chamber 2. Between the second body 3b4 and the drainage pipe 11a, the third valve 3b2 is provided.

An operation of opening the gate unit 3 having such a configuration to pass a fluid from the second chamber 2 to the first chamber 1 via the gate unit 3 will be described.

FIG. 3 shows a state where the gate unit 3 is closed, concretely, a state where the first and second gate plates 3a1 and 3b1 cover the openings of the first and second chambers 1 and 2, that is, a state where the first and second gate valves 3a and 3b are closed.

The first and third valves 3a2 and 3b2 are closed, and the second valve 3a3 is opened. In this state, a chemical is supplied from the chemical pipe 8 into the first chamber 1.

Next, as shown in FIG. 4, the second valve 3a3 is closed. In this state, the supply of the chemical into the first chamber 1 is stopped. Further, the first and second gate valves 3a and 3b are opened.

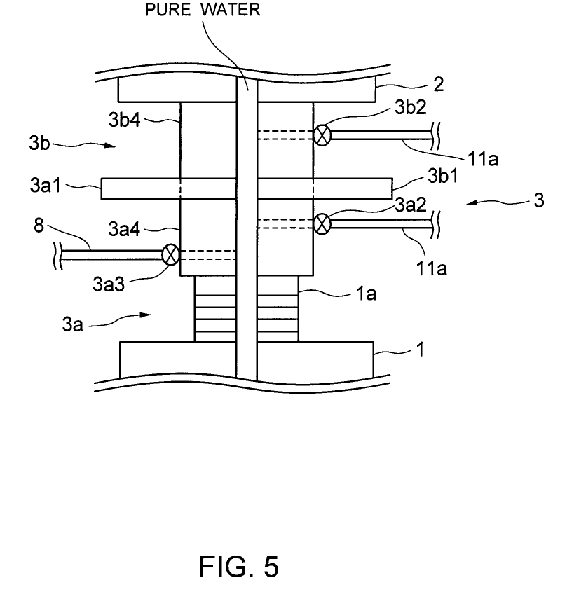

By connecting the first body 3a4 and the second body 3b4 as shown in FIG. 5, a space in the first chamber 1 and a space in the second chamber 2 are connected to each other while maintaining closeness. That is, the gate unit 3 is open.

By supplying, for example, pure water from the replacement-solution pipe 9 into the second chamber 2 in this state, pure water (liquid) can flow between the first and second chambers 1 and 2. At this time, the pure water overflowed from the drainage pipe 11 connected to the first chamber 1 is discharged. By adjusting the supply amount or discharge amount of the pure water, the first and second chambers 1 and 2 can be filled with pure water.

By the above-described operation, the liquid can be passed from the second chamber 2 to the first chamber 1 via the gate unit 3.

As shown in FIG. 2, the wafer carrying device 6 carries the wafer 6a into the first chamber 1 by using an arm 6b and further carries the wafer 6a from the first chamber 1 into the second chamber 2. The wafer carrying device 6 carries the wafer 6a from the second chamber 2 into the first chamber 1 by using the arm 6b and further carries out the wafer 6a from the first chamber 1.

The supercritical fluid supplying device 7 has a tank 7a, a high-pressure pump 7b, and a heater 7c.

The tank 7a stores liquefied carbon dioxide. The high-pressure pump 7b sucks out the carbon dioxide from the tank 7a, pressurizes it, and outputs the pressurized carbon dioxide. The heater 7c heats (increases the temperature of) the carbon dioxide output from the high-pressure pump 7b and outputs the carbon dioxide of the supercritical fluid to the pipe 10.

The ultrasonic generator 12 is provided below the first chamber 1. The ultrasonic generator 12 is configured with, for example, an ultrasonic transducer. The ultrasonic generator 12 applies ultrasonic waves to the liquid (pure water in the embodiment) flowing from the first chamber 1 to the second chamber 2 during carriage of the wafer 6a from the first chamber 1 to the second chamber 2.

By carrying the wafer 6a in a state where the ultrasonic waves are applied to the liquid, adhesion of particles to the wafer 6a during carriage of the wafer 6a between the chambers can be prevented. It is also possible to use IPA as the flowing liquid and apply ultrasonic waves to IPA. In this case, there is a merit that pure water used as a rinse solution existing in fine patterns can be effectively replaced with IPA by the power of the ultrasonic waves.

FIG. 2 shows, as an example, a case where the substrate treatment apparatus 100 is provided with three sets of the first and second chambers 1 and 2. Alternatively, the substrate treatment apparatus 100 may have one set or a plurality of sets of the first and second chambers 1 and 2. For example, the substrate treatment apparatus 100 may have sets of one lot, that is, 25 sets of first and second chambers 1 and 2. With the arrangement, the throughput of the cleaning process can be improved.

The second chamber 2 may be disposed below the first chamber 1.

An example of a substrate treatment method for treating a substrate (wafer) by the substrate treatment apparatus 100 having the above-described configuration will be described.

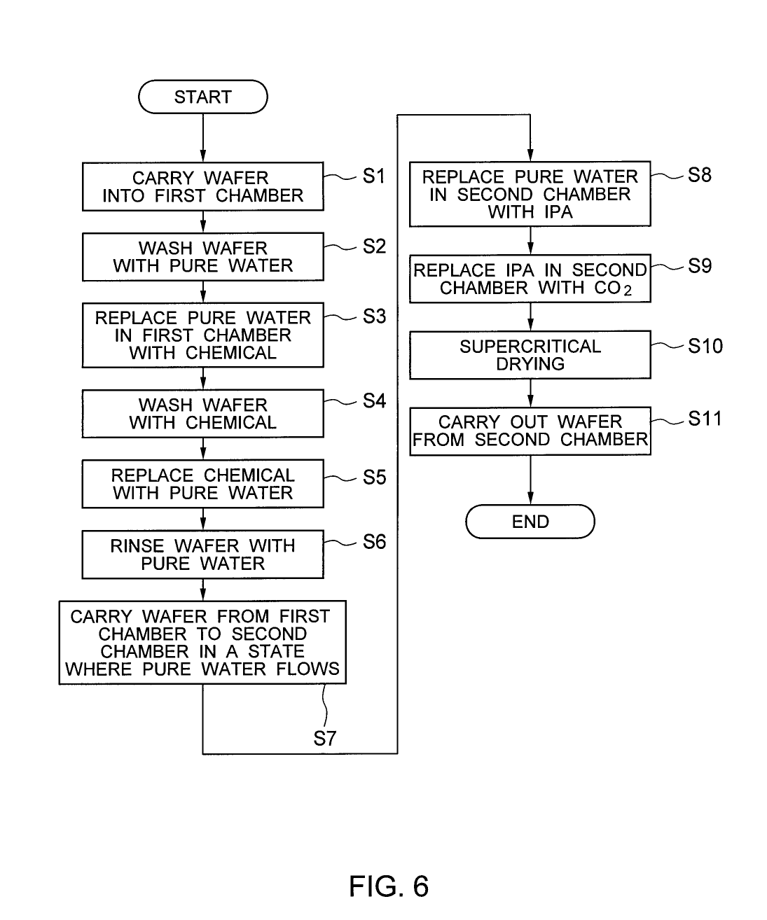

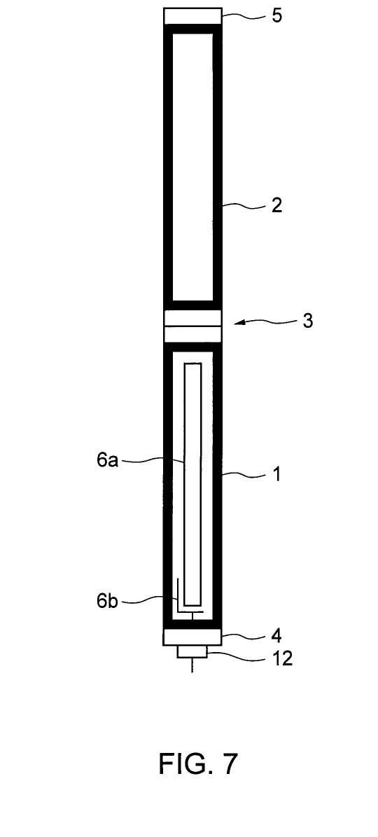

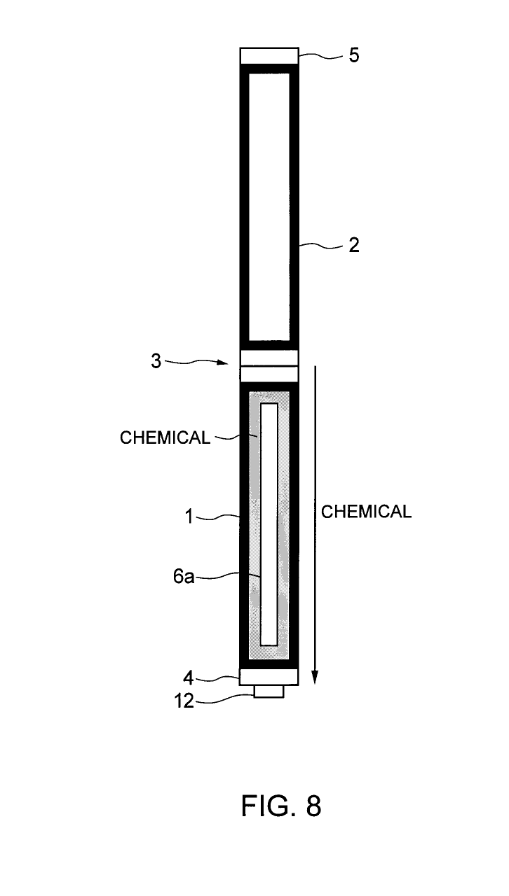

FIG. 6 is a diagram showing a flow of processes of the substrate treatment method performed by the substrate treatment apparatus 100 of the first embodiment. FIGS. 7 to 12 are diagrams showing processes of the substrate treatment method performed by the substrate treatment apparatus 100 of the first embodiment.

As shown in FIG. 6, first, the wafer carrying device 6 carries the wafer (substrate) 6a into the first chamber 1 while supporting the wafer 6a by the arm 6b (step S1 in FIG. 7).

Next, pure water is supplied from the chemical pipe 8 into the first chamber 1 via the gate unit 3. The wafer 6a is cleaned with the pure water in the first chamber 1 (step S2).

A chemical (for example, HF, HCl, H₂O₂, or the like) is supplied from the chemical pipe 8 into the first chamber 1 via the gate unit 3, and the pure water is discharged from the first chamber 1 to the drainage pipe 11. By the operation, the cleaning solution in the first chamber 1 is changed from pure water to the chemical (step S3 and FIG. 8).

Next, the wafer 6a is cleaned with the chemical in the first chamber 1 (step S4).

Pure water is supplied from the chemical pipe 8 into the first chamber 1 via the gate unit 3, and the chemical is discharged from the first chamber 1 to the drainage pipe 11. In such a manner, the chemical in the first chamber 1 is replaced with pure water (step S5).

The wafer 6a is rinsed with the pure water (rinse solution) in the first chamber 1 (step S6).

By the above-described operations shown in FIGS. 3 to 5, the gate unit 3 is opened so that the pure water (liquid) flows between the first and second chambers 1 and 2. In this state, the pure water overflows from the first chamber 1, and the overflowed pure water is discharged from the drainage pipes 11 and 11a. As a result, the first and second chambers 1 and 2 are filled with the pure water.

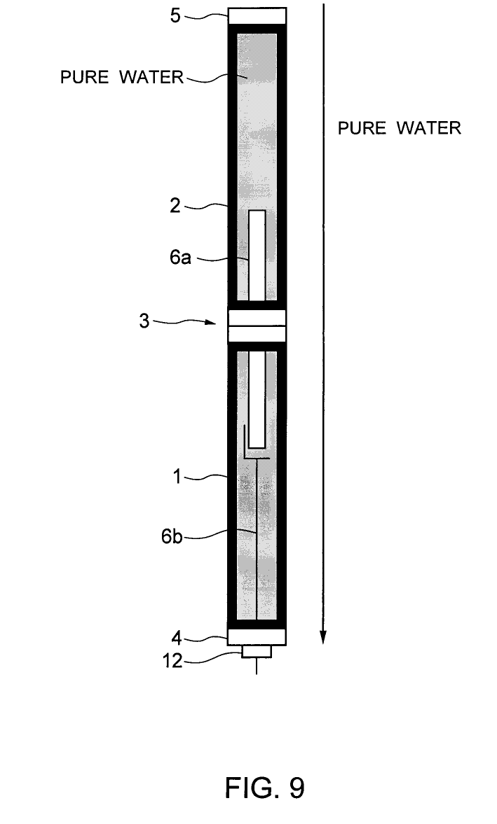

While supporting the wafer 6a by the arm 6b in this state, the wafer carrying device 6 moves the wafer 6a in the pure water so that the flowing direction of the pure water and the board surface of the wafer 6a become parallel to each other. By the operation, the wafer 6a is carried from the first chamber 1 to the second chamber 2 (step S7 and FIG. 9).

In such a manner, at a time of carrying the wafer 6a from the first chamber 1 to the second chamber 2, the surface of the wafer 6a can be prevented from being dried.

In step S7, the ultrasonic generator 12 applies ultrasonic waves to the pure water flowing from the first chamber 1 to the second chamber 2 during carriage of the wafer 6a from the first chamber 1 to the second chamber 2. In the diagrams, the ultrasonic generator 12 is mounted below the first chamber 1. The same effect is obtained also in a case where the ultrasonic generator 12 is mounted on the second chamber 2 side.

By the operation, adhesion of particles to the wafer 6a at a time of carriage of the wafer 6a between the chambers can be prevented.

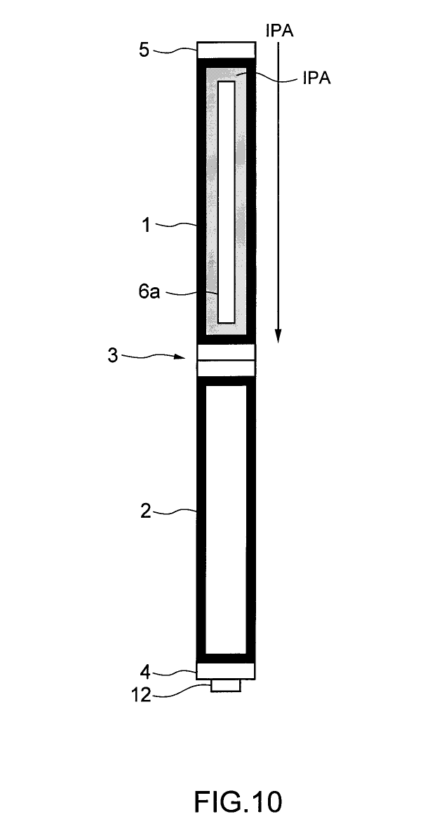

Next, IPA (liquid) is supplied from the replacement-solution pipe 9 to the second chamber 2 via the connection unit 5, and pure water is discharged from the second chamber 2 to the drainage pipe 11a. At this time, by applying ultrasonic waves set for the second chamber 2, the IPA replacing effect can be increased. By the operation, the pure water in the second chamber 2 is changed to IPA (liquid) (step S8 and FIG. 10).

Subsequently, the gate unit 3 is closed (FIG. 3) and the supercritical fluid supplying device 7 supplies carbon dioxide (supercritical fluid) into the second chamber 2 via the pipe 10. At this time, the third valve 3b2 is opened and IPA is discharged to the drainage pipe 11a. In such a manner, the IPA (liquid) in the second chamber 2 is replaced with the carbon dioxide (supercritical fluid) (step S9). In addition, by applying ultrasonic waves set for the second chamber 2, the effect of replacing to the carbon dioxide (supercritical fluid) can be increased.

In step S9, the pressure and/or temperature of the liquefied carbon dioxide is increased by the supercritical fluid supplying device 7 to make the carbon dioxide become a supercritical fluid, and the supercritical fluid is supplied into the second chamber 2 via the pipe 10.

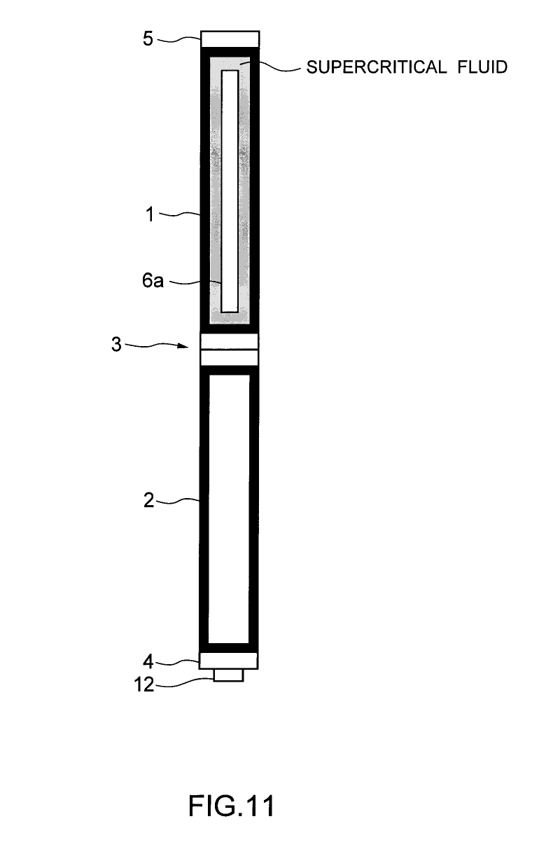

Next, for example, the third valve 3b2 in the second gate valve 3b is opened to discharge the carbon dioxide (supercritical fluid) from the second chamber 2 to the drainage pipe 11a, thereby reducing the pressure in the second chamber 2. It changes the carbon dioxide in the second chamber 2 from a supercritical state to a gas state. Consequently, the wafer 6a is dried in a state where the interface tension (capillary force) is zero without crossing a gas-liquid equilibrium line. That is, by gasifying the supercritical fluid in the second chamber 2, the wafer 6a is subjected to supercritical drying (step S10 and FIG. 11).

Since the wafer 6a is subjected to the supercritical drying process as described above, collapse of patterns formed in the wafer 6a can be suppressed.

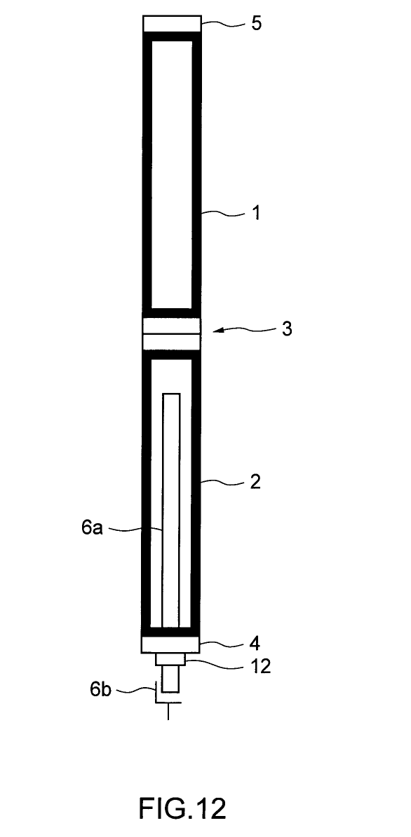

The wafer carrying device 6 carries the wafer 6a out from the second chamber 2 while supporting the wafer 6a with the arm 6b (step S11 and FIG. 12).

By the above flow, the cleaning process, the rinsing process, and the drying process on the wafer 6a are completed.

In the embodiment, the case of replacing the pure water in the second chamber 2 with IPA and changing the IPA to carbon dioxide as a supercritical fluid (that is, the case of replacing the pure water in the second chamber 2 with carbon dioxide as a supercritical fluid via the IPA) has been described.

It is also possible to replace the pure water in the second chamber 2 with carbon dioxide as a supercritical fluid via another liquid. Another liquid may be used as the pure water.

In the embodiment, the direction of the liquid which is passed at a time of carrying the wafer 6a is the direction from the second chamber 2 to the first chamber 1. The direction may be a direction from the first chamber 1 to the second chamber 2.

As described above, the substrate treatment apparatus of the embodiment can suppress collapse of a pattern formed in a substrate.

### Second Embodiment

In the foregoing first embodiment, an example of the configuration for supercritically drying a wafer has been described.

A supercritical fluid used for the supercritical drying has viscosity lower than that of a gas and has a higher power of carrying a material (for example, a particle having a diameter of about 20 nm). It is consequently difficult to sufficiently purge (clean) the material existing in a pipe for supplying a supercritical fluid by a gas in a manner similar to that in a conventional gas pipe.

On the other hand, a liquid has viscosity higher than that of a gas and a supercritical fluid and has a high material carrying force. In a second embodiment, an example of a configuration for purging (cleaning) a pipe for supplying the supercritical fluid by a liquid will be proposed. The basic configuration for supercritically drying a wafer is similar to that of the first embodiment.

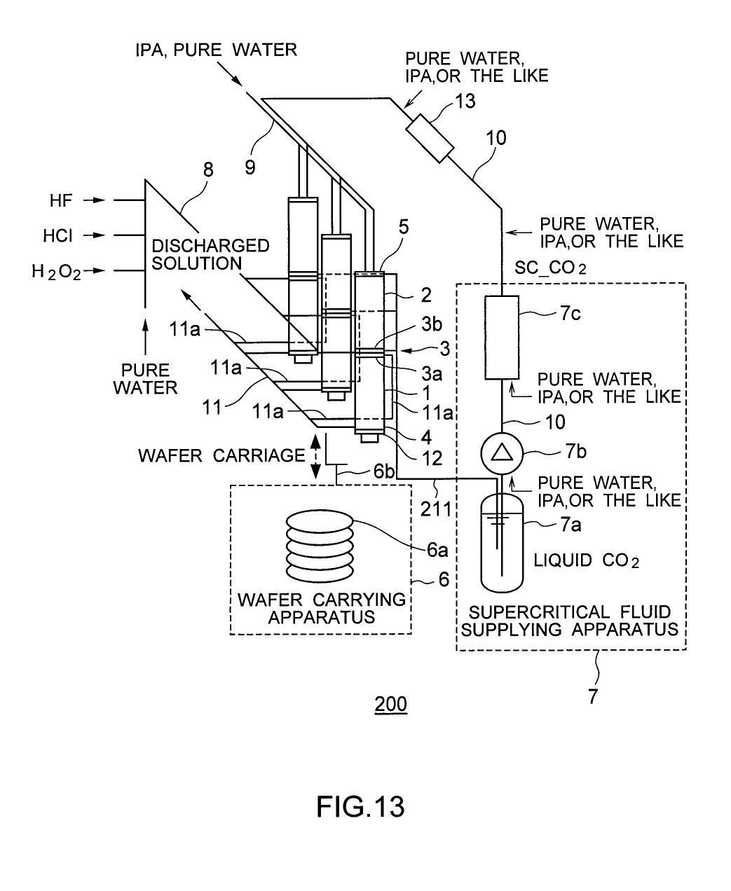

FIG. 13 is a diagram showing an example of the configuration of a substrate treatment apparatus 200 in a second embodiment as an aspect of the present invention. In FIG. 13, the same reference numeral as that in FIG. 2 refers to a configuration similar to that of the substrate treatment apparatus 100 in the first embodiment.

As shown in FIG. 13, the substrate treatment apparatus 200 includes the first chamber 1, the second chamber 2, the gate unit 3, the connection units 4 and 5, the wafer carrying device 6, the supercritical fluid supplying device 7, the cleaning-solution pipe 8, the replacement-solution pipe 9, the pipe 10, drainage pipes 11, 11a, and 211, the ultrasonic generator 12, and a filter 13.

The substrate treatment apparatus 200 includes the drainage pipe 211 for discharging carbon dioxide discharged from the second gate valve 3b to the tank 7a in place of the drainage pipe 11a connected to the second gate valve 3b in the first embodiment.

In a manner similar to the first embodiment, the supercritical fluid supplying device 7 is configured with the tank 7a, the high-pressure pump 7b, and the heater 7c.

The tank 7a is connected to the pipe 10 and the drainage pipe 211. The tank 7a stores a liquid (liquefied carbon dioxide) which is a supercritical fluid in a liquid state discharged from the drainage pipe 211.

In a manner similar to the first embodiment, the high-pressure pump 7b is provided for the pipe 10, sucks out a liquid (liquefied carbon dioxide) from the tank 7a, pressurizes the liquid (liquefied carbon dioxide), and outputs the pressurized carbon dioxide.

In a manner similar to the first embodiment, the heater 7c is provided for the pipe 10 and is positioned between the high-pressure pump 7b and the second chamber 2. The heater 7c heats the liquid (liquefied carbon dioxide) output from the high-pressure pump 7b to lead the liquid to a supercritical fluid.

The filter 13 is provided for the pipe 10 and is positioned between the heater 7c and the second chamber 2. The filter 13 filters a particle having a diameter of about 3 nm included in the supercritical fluid.

An example of operation of purging (cleaning) the pipe 10 for supplying a supercritical fluid in the substrate treatment apparatus 200 having the above-described configuration by a liquid will be described.

Prior to cleaning with a chemical, the substrate treatment apparatus 200 cleans the inside of the pipe 10 by making pure water flow in the pipe 10, discharging the pure water, after that, making a cleaning solution having a vapor pressure higher than that of pure water flow in the pipe 10, and discharging the cleaning solution. Pure water is selected as a liquid capable of removing a particle of about 20 nm.

In particular, the substrate treatment apparatus 200 sequentially supplies pure water and the cleaning solution into the pipe 10 from between the tank 7a and the high-pressure pump 7b, between the high-pressure pump 7b and the heater 7c, between the heater 7c and the filter 13, or between the filter 13 and the second chamber 2, and makes them flow into the second chamber 2.

In such a manner, a material (for example, a particle having a diameter of about 20 nm) in the pipe 10 can be efficiently removed, and the inside of the pipe 10 can be efficiently purged (cleaned).

For example, in a case of sequentially supplying pure water and a cleaning solution from between the filter 13 and the second chamber 2, a particle which cannot be removed by the filter 13 and a particle which is generated when the pipe 10 is constructed can be removed.

For example, in a case of sequentially supplying pure water and a cleaning solution from between the heater 7c and the filter 13, a particle generating in a tank 7 or a high pressure pump 7b and residing between the heater 7c in the pipe 10 and the filter 13 can be removed.

Further, as described above, by making pure water flow in the pipe 10, making a cleaning solution having vapor pressure higher than that of the pure water flow in the pipe 10, and discharging the cleaning solution, residence of the liquid in the pipe 10 can be suppressed. Particularly, in a case where the pipe 10 is made of SUS, corrosion in the pipe 10 can be suppressed.

The cleaning solution is, for example, alcohol. This alcohol is, for example, IPA or HFE. The IPA and HFE (Hydro Fluoro Ether) are selected as liquids capable of removing a particle having a diameter of about 20 nm.

IPA may flow in the pipe 10 and be discharged therefrom and, after that, HFE may flow in the pipe 10 and be discharged therefrom.

The pure water and the cleaning solution flowed in the pipe 10 is discharged via the second chamber 2, the first chamber 1, and the drainage pipes 11a and 11. The pure water and the cleaning solution flowed in the pipe 10 may also flow in the drain pipe 211. As described above, by the substrate treatment apparatus of the embodiment, while suppressing collapse of a pattern formed on the substrate, a particle or the like residing in a pipe can be effectively removed.

What is claimed is:

1. A substrate treatment apparatus for treating a substrate on which a plurality of patterns are formed adjacently, comprising:
a first chamber which has resistance to a chemical and cleans the substrate with the chemical;
a second chamber which is disposed above or below the first chamber, has higher pressure resistance than the first chamber, and supercritically dries the substrate; and
a gate unit which is provided between the first and second chambers and can be opened/closed,
wherein the substrate is cleaned with the chemical in the first chamber,
the gate unit is opened to make a first liquid flow between the first and second chambers and the substrate is moved in the first liquid in a manner such that a board surface of the substrate becomes parallel to a flowing direction of the first liquid, thereby carrying the substrate from the first chamber to the second chamber via the gate unit,
a supercritical fluid is supplied into the second chamber to replace the first liquid in the second chamber with the supercritical fluid, and
the substrate is subjected to supercritical drying in the second chamber.

2. The substrate treatment apparatus according to claim 1, further comprising an ultrasonic generator which applies ultrasonic waves to the first liquid during carriage of the substrate from the first chamber to the second chamber.

3. The substrate treatment apparatus according to claim 1, wherein the second chamber is made of SUS.

4. The substrate treatment apparatus according to claim 1, wherein the chemical is H₂SO₄, HF, HCl, H₂O₂, NH₄OH or choline.

5. The substrate treatment apparatus according to claim 1, wherein the supercritical fluid is carbon dioxide.

6. The substrate treatment apparatus according to claim 1, further comprising a pipe which is connected to the second chamber and is supplies the supercritical fluid into the second chamber,
wherein prior to cleaning with the chemical, pure water is made flow in the pipe, and then a cleaning solution having vapor pressure higher than that of pure water is made flow in the pipe and discharged, thereby cleaning the inside of the pipe.

7. The substrate treatment apparatus according to claim 6, further comprising:
a tank which is connected to the pipe and stores a second liquid that is the supercritical fluid in a liquid state;
a high-pressure pump which is provided for the pipe, sucks the second liquid from the tank, pressurizes the second liquid, and outputs the pressurized second liquid;
a heater which is provided for the pipe, is positioned between the high-pressure pump and the second chamber, and heats the second liquid output from the high-pressure pump to lead the second liquid to the supercritical fluid; and
a filter which is provided for the pipe, is positioned between the heater and the second chamber, and filters a particle included in the supercritical fluid,
wherein the pure water and the cleaning solution are sequentially supplied into the pipe from between the tank and the high-pressure pump, between the high-pressure pump and the heater, between the heater and the filter, or between the filter and the second chamber, and are made flow into the second chamber.

8. The substrate treatment apparatus according to claim 6, wherein the cleaning solution is IPA or HFE.

9. A substrate treatment method for treating a substrate on which a plurality of patterns are formed adjacently, comprising:
cleaning the substrate with a chemical in a first chamber having resistance to the chemical;
in a state where a first liquid flows between the first chamber and a second chamber having higher pressure resistance than the first chamber, moving the substrate in the first liquid in such a manner that a substrate face of the substrate is parallel to a flowing direction of the first liquid to thereby carry the substrate from the first chamber to the second chamber;
supplying a supercritical fluid into the second chamber to replace the first liquid in the second chamber with the supercritical fluid; and
performing supercritical drying on the substrate in the second chamber.

10. The substrate treatment method according to claim 9, wherein the supercritical fluid is carbon dioxide.

11. The substrate treatment method according to claim 9, further comprising an ultrasonic generator which applies ultrasonic waves to the first liquid during carriage of the substrate from the first chamber to the second chamber.

12. The substrate treatment method according to claim 9,
wherein a pipe is connected to the second chamber and is supplies the supercritical fluid into the second chamber,
wherein prior to cleaning with the chemical, pure water is made flow in the pipe, and then a cleaning solution having vapor pressure higher than that of pure water is made flow in the pipe and discharged, thereby cleaning the inside of the pipe.

13. The substrate treatment method according to claim 12,
wherein the pipe is connected to a tank, the tank storing a second liquid that is the supercritical fluid in a liquid state,
the pipe is provided with a high-pressure pump, the high-pressure pump sucking the second liquid from the tank, pressurizing the second liquid and outputting the pressurized second liquid,
the pipe is provided with a heater, the heater positioned between the high-pressure pump and the second chamber and heating the second liquid output from the high-pressure pump to lead the second liquid to the supercritical fluid, and
the pipe is provided with a filter, the filter positioned between the heater and the second chamber and filtering a particle included in the supercritical fluid,
wherein the pure water and the cleaning solution are sequentially supplied into the pipe from between the tank and the high-pressure pump, between the high-pressure pump and the heater, between the heater and the filter, or between the filter and the second chamber, and are made flow into the second chamber.

14. The substrate treatment method according to claim 10, wherein the chemical is H₂SO₄, HF, HCl, H₂O₂, NH₄OH or choline.

15. A substrate treatment apparatus for treating a substrate, comprising:
a chamber which supercritically dries the substrate; and
a pipe which is connected to the chamber and is supplies the supercritical fluid into the chamber,
wherein pure water is made flow in the pipe, and then a cleaning solution having vapor pressure higher than that of pure water is made flow in the pipe and discharged, thereby cleaning the inside of the pipe.

16. The substrate treatment apparatus according to claim 15, further comprising:
a tank which is connected to the pipe and stores a first liquid that is the supercritical fluid in a liquid state;
a high-pressure pump which is provided for the pipe, sucks the first liquid from the tank, pressurizes the first liquid, and outputs the pressurized first liquid;
a heater which is provided for the pipe, is positioned between the high-pressure pump and the chamber, and heats the first liquid output from the high-pressure pump to lead the first liquid to the supercritical fluid; and
a filter which is provided for the pipe, is positioned between the heater and the chamber, and filters a particle included in the supercritical fluid,
wherein the pure water and the cleaning solution are sequentially supplied into the pipe from between the tank and the high-pressure pump, between the high-pressure pump and the heater, between the heater and the filter, or between the filter and the chamber, and are made flow into the chamber.

17. The substrate treatment apparatus according to claim 15, wherein the cleaning solution is alcohol.

18. The substrate treatment apparatus according to claim 17, wherein the alcohol is IPA or HFE.

19. The substrate treatment apparatus according to claim 15, wherein the chamber is made of SUS.

20. The substrate treatment apparatus according to claim 15, wherein the supercritical fluid is carbon dioxide.
